(19) United States
(12) Patent Application Publication
(10) Pub. No.: US 2015/0143041 A1
(43) Pub. Date: May 21, 2015

(54) STORAGE CONTROL APPARATUS AND CONTROL METHOD

(71) Applicant: FUJITSU LIMITED, Kawasaki-shi (JP)

(72) Inventor: Kenji Hattori, Odawara (JP)

(21) Appl. No.: 14/533,465

(22) Filed: Nov. 5, 2014

(30) Foreign Application Priority Data
Nov. 15, 2013 (JP) 2013-236654

(51) Int. Cl. G06F 3/06

(52) U.S. Cl. CPC G06F 3/0665; G06F 3/0689; G06F 3/0619
USPC 711/114

(57) ABSTRACT

A storage control apparatus includes a plurality of control units that each controls access to one or more first storage areas among a plurality of first storage areas allocated to one or more storage media, and a storage unit configured to store information, for each of the control units, on one or more second storage areas to which unit storage areas reserved in the corresponding one or more first storage areas are allocated. When one of the control units receives an access request to a unit storage area reserved in a first storage area different from the corresponding one or more first storage areas, the one of the control units provides information on the control unit that controls access to the different first storage area as an access path to the unit storage area.

### CROSS-REFERENCE TO RELATED APPLICATION

This application is based upon and claims the benefit of priority of the prior Japanese Patent Application No. 2013-236654, filed on Nov. 15, 2013, the entire contents of which are incorporated herein by reference.

### FIELD

The embodiments discussed herein are related to a storage control apparatus and a control method.

### BACKGROUND

Computers (hereinafter “servers”) such as business servers and the like handle a large amount of data. Such data is managed by using a storage apparatus such as a redundant arrays of inexpensive disks (RAID) apparatus which includes multiple hard disk drives (HDDs) and which has high reliability. Recently, a storage system called a storage area network (SAN) has been widely used in which servers and multiple storage apparatuses are connected via a network.

The storage area (hereinafter “physical area”) of a storage apparatus is divided into logical units (hereinafter “LUs”) of the storage area, and is recognized by a server on a LU basis. For example, each LU is assigned identification information called a logical unit number (LUN). Thus, the server is able to identify each LU by referring to the LUN. Note that a LU assigned to each RAID group may be referred to as a RAID LU (RLU).

In recent years, storage virtualization has been attracting attention. Storage virtualization is a technique of providing a virtual engine between storage apparatuses and a server such that the virtual engine appears to the server as a single virtual storage apparatus. The virtual engine provides virtual LUs which are different from LUs obtained by dividing the physical area (hereinafter “physical LUs”), and allocates the storage area selected from one or more physical LUs to the virtual LUs.

By introducing virtual LUs, the relationship between the storage area recognized by the server and the physical area is highly abstracted. This may improve the utilization efficiency and the flexibility in the operation form. In the case where storage virtualization is applied, the server accesses a virtual LU when reading or writing data. That is, the server realizes access to a physical LU via the virtual engine. In connection with storage systems having such a structure, there has been disclosed a method that builds a multipath environment which provides redundant access paths from a server to a physical LU.

In a multipath environment, even when a failure occurs in an access path, operations may be continued by using another access path that is available. This contributes to improving the reliability of the storage system. When selecting an access path in a multipath environment, a REPORT TARGET PORT GROUPS (RTPG) command may be used, for example. An RTPG command is one of Small Computer System Interface (SCSI) commands. A server issues an RTPG command to a storage apparatus. The storage apparatus having received the RTPG command reports a recommended access path (hereinafter “recommended path”) to the server. Then, the server reads or writes data using the reported recommended path.

As one technique for improving the utilization of the physical area in a virtual storage system, there is a technique called thin provisioning. In a typical storage system, a physical area of the size requested by a server is allocated to a virtual LU. On the other hand, in a storage system to which thin provisioning is applied, although a virtual LU (hereinafter “thin provisioning volume (TPV)”) of a requested size is provided, a physical area of a size corresponding to the usage is allocated, and the size of the physical area to be allocated may be increased up to the requested size. This makes it possible to operate the storage system in accordance with the actual operations, and may improve the utilization and reduce the cost of starting operations.

In connection with a virtual storage system, there has been disclosed a method that suitably controls allocation of the physical area to a virtual LU in order to prevent fragmentation and to improve the usage efficiency of the physical area. Further, in connection with allocation of the physical area to a TPV, there has been disclosed a method that specifies an unallocated physical area with reference to management information, divides the specified unallocated physical area into a plurality of subareas, and allocates the subareas to continuous areas arranged at regular intervals in a TPV.

Please see, for example, Japanese Laid-open Patent Publications Nos. 2007-157089, 2004-164370, and 2008-59353.

As mentioned above, when selecting an access path in a multipath environment, a storage apparatus reports a recommended path to a server. In the case where a single recommended path is determined for a physical LU, the recommended path may be reported using an RTPG command as described above. In the case where there are more than one recommended paths (for example, in the case where a TPV is used), recommended paths for respective Logical Block Addressing (LBA) ranges may be reported using a REPORT REFERRALS (RR) command. Note that an RR command is one of SCSI commands.

One way to report a recommended path may be to report a recommended path immediately after the areas of physical LUs are allocated to virtual LUs and an access path is determined, for example. However, in the case where thin provisioning is applied, an access path is determined each time an access is made to an unused LBA range of a TPV. Therefore, if the above-described reporting method is used in a storage system to which thin provisioning is applied, reporting of a recommended path is performed frequently. This might increase the processing load for updating management information of a recommended path.

### SUMMARY

According to one aspect of the invention, there is provided a storage control apparatus including: a plurality of processors that each controls access to one or more first storage areas among a plurality of first storage areas allocated to one or more data storage media; and a memory configured to store information, for each of the processors, on one or more second storage areas to which unit storage areas reserved in the corresponding one or more first storage areas are allocated. When one of the processors receives an access request to a unit storage area reserved in a first storage area different from the corresponding one or more first storage areas, the one of the processors provides information on another of the processors that controls access to the different first storage area as an access path to the unit storage area.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a storage system according to a first embodiment;

FIG. 2 is a first diagram illustrating a storage system according to a second embodiment;

FIG. 3 is a second diagram illustrating the storage system according to the second embodiment;

FIG. 4 is a first diagram illustrating a recommended path management method according to the second embodiment;

FIG. 5 is a second diagram illustrating a recommended path management method according to the second embodiment;

FIG. 6 is a third diagram illustrating a recommended path management method according to the second embodiment;

FIG. 7 illustrates an example of the hardware capable of realizing functions of a server according to the second embodiment;

FIG. 8 illustrates the functions of a storage control apparatus according to the second embodiment;

FIG. 9 illustrates an example of a path status management table stored in the storage control apparatus according to the second embodiment;

FIG. 10 illustrates an example of a logical volume management table stored in the storage control apparatus according to the second embodiment;

FIG. 11 illustrates an example of a logical block management table stored in the storage control apparatus according to the second embodiment;

FIG. 12 illustrates an example of a sense notification count management table stored in the storage control apparatus according to the second embodiment;

FIG. 13 illustrates an example of operations of the storage system (operations upon recognition) according to the second embodiment;

FIG. 14 is a first diagram illustrating an example of operations of the storage system (operations upon cross-access detection) according to the second embodiment; and

FIG. 15 is a second diagram illustrating an example of operations of the storage system (operations upon cross-access detection) according to the second embodiment.

### DESCRIPTION OF EMBODIMENTS

Hereinafter, embodiments will be described with reference to the accompanying drawings. Like reference numerals refer to like elements throughout, and description of like elements will not be repeated.

### (1) First Embodiment

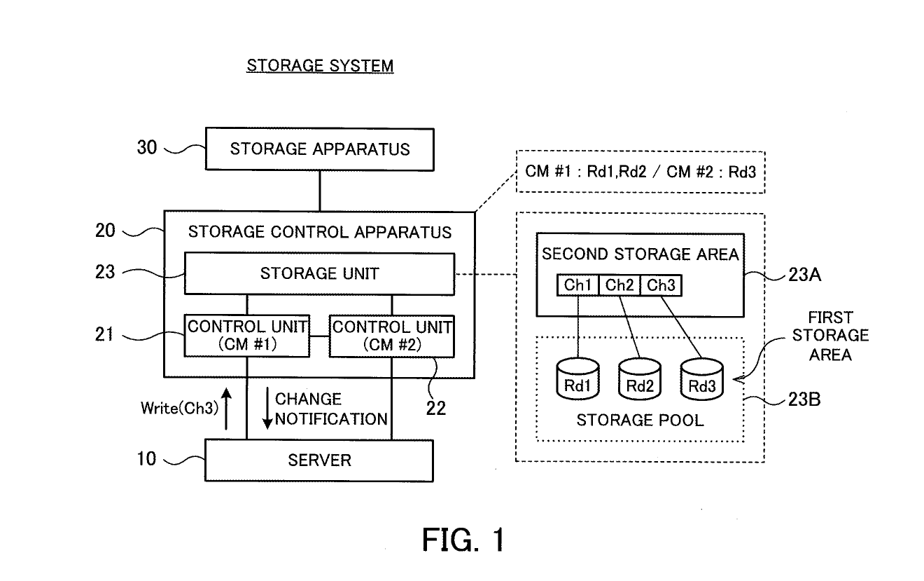

A storage system according to a first embodiment will be described with reference to FIG. 1. FIG. 1 illustrates an example of the storage system according to the first embodiment.

As illustrated in FIG. 1, the storage system of the first embodiment includes a server 10, a storage control apparatus 20, and a storage apparatus 30.

The server 10 accesses one or more storage media included in the storage apparatus 30 via the storage control apparatus 20. As the storage media, magnetic storage media (such as HDDs, magnetic tapes, and the like), optical storage media (such as optical discs and the like), and semiconductor memories (such as solid state drives (SSDs) and the like) may be used, for example. A RAID apparatus is an example of the storage apparatus 30.

The storage control apparatus 20 includes control units 21 and 22, and a storage unit 23. In the example of FIG. 1, the storage control apparatus 20 includes two control units (the control units 21 and 22). However, the storage control apparatus 20 may include three or more control units. Further, in the example of FIG. 1, the control unit 21 is denoted by CM #1, and the control unit 22 is denoted by CM #2.

The storage unit 23 may be a volatile storage device such as a random access memory (RAM) and the like, or may be a non-volatile storage device such as a hard disk drive (HDD), a flash memory, and the like. The control units 21 and 22 may be, for example, processors such as central processing units (CPUs), digital signal processors (DSPs), and the like. Alternatively, the control units 21 and 22 may be electronic circuits such as application specific integrated circuits (ASICs), field programmable gate arrays (FPGAs), and the like. The control units 21 and 22 execute programs stored in the storage unit 23 or other memories, for example.

The control units 21 and 22 are respectively associated with multiple first storage areas Rd1, Rd2, and Rd3 allocated to one or more storage media included in the storage apparatus 30. Note that the above-described physical LUs and RLUs are examples of first storage areas. Further, the multiple first storage areas Rd1, Rd2, and Rd3 are registered in a storage pool 23B managed by the control units 21 and 22. In the example of FIG. 1, three first storage areas (the first storage areas Rd1, Rd2, and Rd3) are registered in the storage pool 23B. However, less than three or more than three first storage areas may be registered in the storage pool 23B.

Each of the control units 21 and 22 is able to access the corresponding one or more first storage areas Rd1, Rd2, and Rd3. In the example of FIG. 1, the control unit 21 (CM #1) is associated with the first storage areas Rd1 and Rd2, and the control unit 22 (CM #2) is associated with the first storage area Rd3. Accordingly, the control unit 21 is able to access the first storage areas Rd1 and Rd2. The control unit 22 is able to access the first storage area Rd3.

The storage unit 23 stores information on the storage pool 23B, and information on the first storage areas Rd1, Rd2, and Rd3 registered in the storage pool 23B. Further, the storage unit 23 stores information on a second storage area 23A. The second storage area 23A is a logical storage area (logical volume). The above-described TPV is an example of the second storage area. Note that, in the example of FIG. 1, only one second storage area 23A is provided. However, two or more second storage areas may be provided.

Unit storage areas Ch1, Ch2, and so on of a specified size are allocated to the second storage area 23A. Further, a part or all of the physical area of the first storage areas Rd1, Rd2, and Rd3 is allocated to each of the unit storage areas Ch1, Ch2, and so on. In the example of FIG. 1, a part or all of the physical area of the first storage area Rd1 is allocated to the unit storage area Ch1. A part or all of the physical area of the first storage area Rd2 is allocated to the unit storage area Ch2. A part or all of the physical area of the first storage area Rd3 is allocated to the unit storage area Ch3. Note that unit blocks (chunks) allocated to the above-described TPV are an example of the unit storage areas.

As described above, for each of the control units 21 and 22, the unit storage areas Ch1, Ch2, and so on reserved in the corresponding one or more first storage areas Rd1, Rd2, and Rd3 are allocated to the second storage area 23A.

In the example of FIG. 1, the unit storage areas Ch1 and Ch2 reserved in the first storage areas Rd1 and Rd2 accessible by the control unit 21 and the unit storage area Ch3 reserved in the first storage area Rd3 accessible by the control unit 22 are present together in the second storage area 23A. That is, the storage control apparatus 20 allows the unit storage areas Ch1 and Ch2 with an access path via the control unit 21 and the unit storage area Ch3 with an access path via the control unit 22 to be present together in the same second storage area 23A.

When the control unit 21 receives an access request to the unit storage area Ch3 reserved in the first storage area Rd3 different from the corresponding first storage areas Rd1 and Rd2, the control unit 21 provides information on the control unit 22 corresponding to the first storage area Rd3 as an access path to the unit storage area Ch3. For example, upon receiving from the server 10 a command (Write command) for writing data to the unit storage area Ch3, the control unit 21 provides the server 10 with information on the control unit 22 corresponding to the unit storage area Ch3.

When accessing the first storage area Rd3, the control unit 21 accesses the first storage area Rd3 via the control unit 22, which is able to access the first storage area Rd3. For example, upon receiving a Write command to the unit storage area Ch3 to which the physical area of the first storage area Rd3 is allocated, the control unit 21 writes data to the first storage area Rd3 via the control unit 22. Such an access to a physical area from a control unit via another control unit is called a cross-access. The occurrence of a cross-access might be a factor of reducing the access performance.

Therefore, the control units 21 and 22 provide the server 10 with information on an access path (hereinafter “recommended path”) that prevents a cross-access from occurring. Thus, the server 10 uses the information on a recommended path. This makes it possible to prevent a cross-access from occurring, and may improve the access performance. Information on a recommended path is managed for each of the unit storage areas Ch1, Ch2, Ch3, and so on. Further, in the case where a new unit storage area is provided in the second storage area 23A, an operation is performed that provides the server 10 with a new recommended path to the new unit storage area.

In situations in which unit storage areas are frequently created, such as when starting operations of the storage system, an operation of providing the server 10 with recommended path information might be performed frequently. If such an operation is performed frequently, the processing load on the control units 21 and 22 and the communication load between the server 10 and the storage control apparatus 20 might be increased. In view of that, the control units 21 and 22 of the first embodiment provide the server 10 with recommended path information when a cross-access occurs. In this case, the control units 21 and 22 provide the server 10 with, not information on recommended paths to all the unit storage areas Ch1, Ch2, and Ch3 registered in the second storage area 23A, but information on a recommended path with respect to the access path with which the cross-access occurred.

With this structure, the storage control apparatus 20 may prevent a reduction in the access performance due to a cross-access. Further, the storage control apparatus 20 may reduce the processing load for the operation of providing the server 10 with recommended path information (processing load for updating a recommended path).

The above is a description of the first embodiment.

### (2) Second Embodiment

The following describes a second embodiment.

(2-1) System

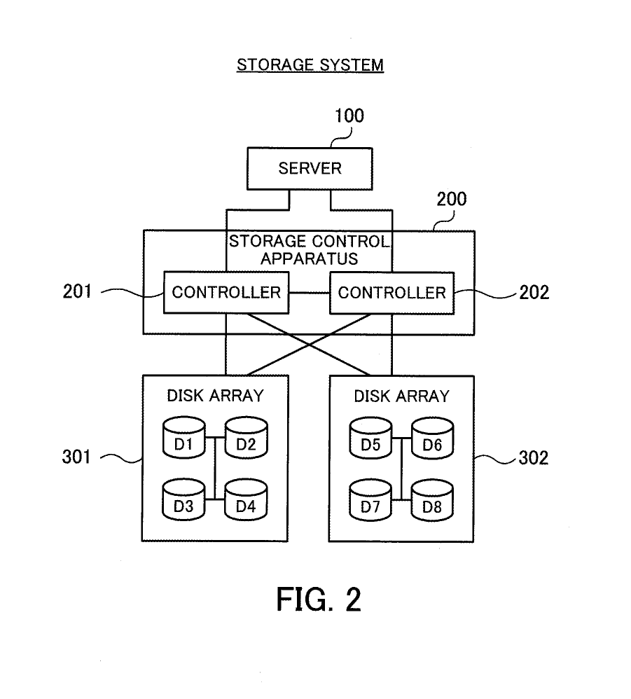

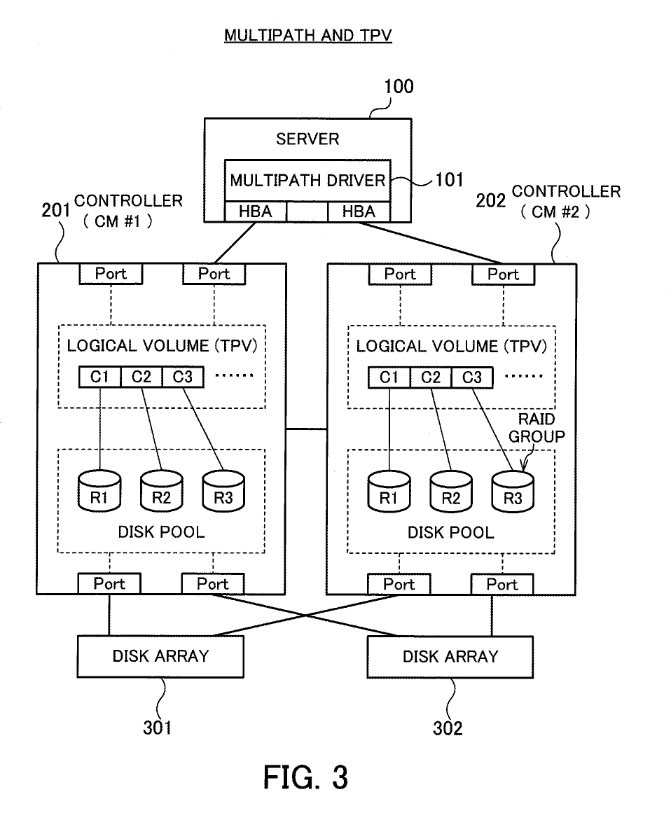

First, a storage system according to a second embodiment will be described with reference to FIGS. 2 and 3. FIG. 2 is a first diagram illustrating a storage system according to the second embodiment. FIG. 3 is a second diagram illustrating the storage system according to the second embodiment.

As illustrated in FIG. 2, the storage system of the second embodiment includes a server 100, a storage control apparatus 200, and disk arrays 301 and 302.

The server 100 accesses the disk arrays 301 and 302 via the storage control apparatus 200. The disk array 301 includes multiple storage media D1, D2, D3, and D4. The disk array 302 includes multiple storage media D5, D6, D7, and D8. As the storage media, magnetic storage media (such as HDDs, magnetic tapes, and the like), optical storage media (such as optical discs and the like), and semiconductor memories (such as SSDs and the like) may be used, for example. A RAID apparatus is an example of the disk arrays 301 and 302.

The storage control apparatus 200 includes controllers 201 and 202. In the example of FIG. 2, the storage control apparatus 200 includes two controllers (the controllers 201 and 202). However, the storage control apparatus 200 may include three or more controllers. Hereinafter, the controller 201 may be referred to also as a CM #1, and the controller 202 may be referred to also as a CM #2.

As illustrated in FIG. 3, the server 100 includes a multipath driver 101 that manages access paths to the disk arrays 301 and 302 via the storage control apparatus 200. The server 100 includes multiple host bus adapters (HBAs), which are respectively connected to the ports of the controllers 201 and 202 of the storage control apparatus 200. The multipath driver 101 accesses the controllers 201 and 202 via the HBAs. Further, the multipath driver 101 manages information on preferred access paths (recommended paths) to be used for accessing the physical area.

The controllers 201 and 202 manage the logical volumes storing logical storage areas provided to the server 100, and disk pools to which the physical areas of the disk arrays 301 and 302 are allocated. In the following, it is assumed for simplicity that the logical volumes managed by the controllers 201 and 202 are TPVs. Further, it is assumed that RAID groups R1, R2, R3 obtained by dividing the physical area of each of the disk arrays 301 and 302 are registered in the disk pool. The physical area of the RAID group Rk (k=1, 2, 3) is hereinafter referred to as an RLU area Rk.

The controller 201 is configured to be able to access the RLU areas R1 and R2, and the controller 202 is configured to be able to access the RLU area R3. That is, it is assumed that the controller 201 is a controller responsible for the RLU areas R1 and R2, and the controller 202 is a controller responsible for the RLU area R3.

Logical units of the storage area called chunks are allocated to a TPV. A part or all of the RLU area is allocated to each chunk. In the example of FIG. 3, chunks C1, C2, C3, and so on are allocated to the TPV. The RLU area R1 is allocated to the chunk C1; the RLU area R2 is allocated to the chunk C2; and the RLU area R3 is allocated to the chunk C3.

A chunk is generated when the controllers 201 and 202 receive from the server 100 a command (Write command) requesting writing of data. For example, in the case of writing data in an area beyond the RLU area allocated to an existing chunk, a new chunk is generated, and data is written to an RLU area allocated to the new chunk.

When accessing data in the TPV, the server 100 causes the multipath driver 101 to select an access path. For example, if an access request to the chunk C3 to which the RLU area R3 is allocated is transmitted to the controller 201, since the controller 202 is responsible for the RLU area R3, the controller 201 accesses the RLU area R3 via the controller 202. That is, a cross-access occurs. Accordingly, the multipath driver 101 selects an access path (recommended path) that causes the access request to the chunk C3 to be transmitted to the controller 202, and thereby prevents a cross-access from occurring.

The multipath driver 101 acquires information on recommended paths for respective LBA ranges of the TPV using an RR command, for example. The multipath driver 101 stores the acquired recommended path information, and uses the stored recommended path information when selecting an access path. In this way, since the recommended path information is managed for each LBA range, even when multiple chunks to which RLU areas with different responsible controllers are allocated are present together in one TPV, the multipath driver 101 is able to select a recommended path.

(Recommended Path Management Method)

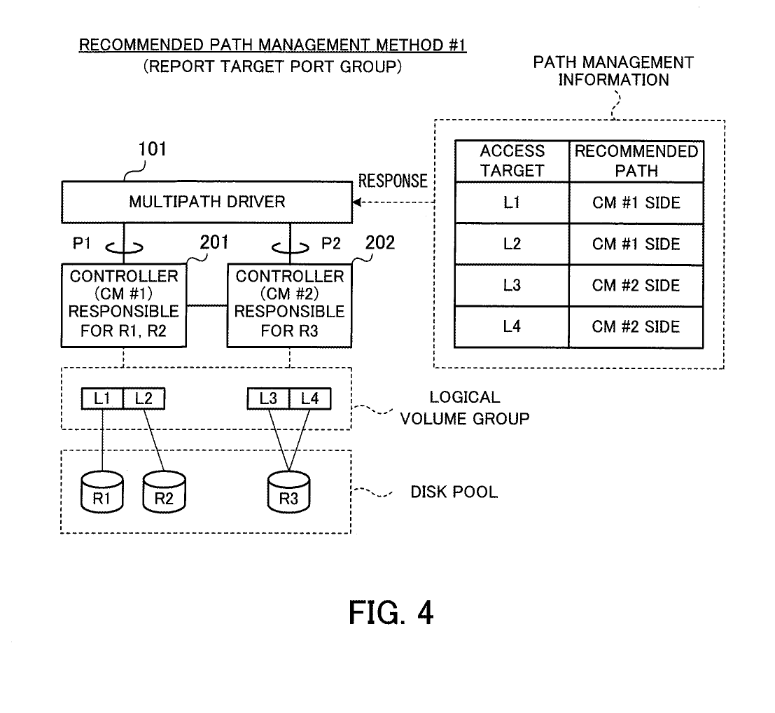

Now, a recommended path management method used by the storage system of the second embodiment will be described in greater detail with reference to FIGS. 4 through 6.

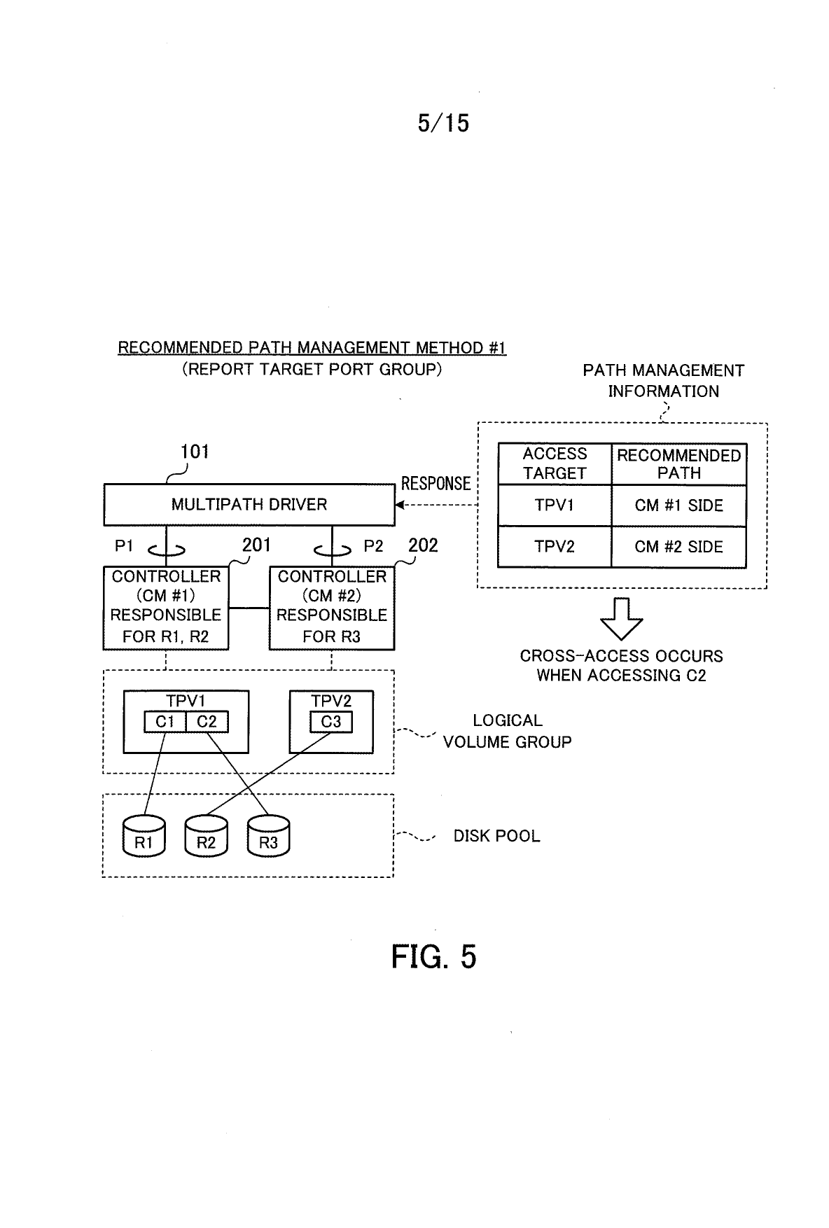

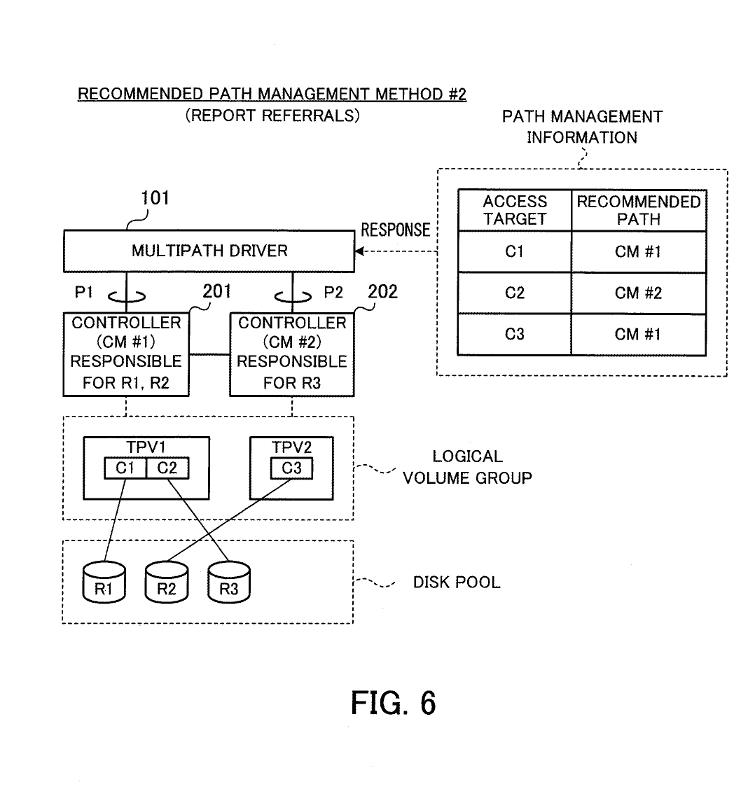

FIG. 4 is a first diagram illustrating a recommended path management method according to the second embodiment. FIG. 5 is a second diagram illustrating a recommended path management method according to the second embodiment. FIG. 6 is a third diagram illustrating a recommended path management method according to the second embodiment.

The recommended path management method includes, for example, a management method (hereinafter “management method #1”) on a logical volume basis using the RTPG command described above and a management method (management method #2) on an LBA basis using the RR command described above. FIG. 4 illustrates a method of managing recommended paths on a logical volume basis. For example, if each logical volume does not include multiple RLU areas with different responsible controllers, the management method #1 may be applied.

In the case of the management method #1, path management information for managing recommended paths is information that associates access target logical volumes (L1, . . . , and L4) with recommended paths. In the example of FIG. 4, the controller responsible for an RLU area R1 allocated to a logical volume L1 is the CM #1. Accordingly, the recommended path for accessing the logical volume L1 is specified as an access path (P1) via the CM #1. Likewise, the controller responsible for an RLU area R2 allocated to a logical volume L2 is the CM #1. Accordingly, the recommended path for accessing the logical volume L2 is specified as the access path (P1) via the CM #1.

Further, the controller responsible for an RLU area R3 allocated to a logical volume L3 is the CM #2. Accordingly, the recommended path for accessing the logical volume L3 is specified as an access path (P2) via the CM #2. Likewise, the controller responsible for the RLU area R3 allocated to a logical volume L4 is the CM #2. Accordingly, the recommended path for accessing the logical volume L4 is specified as the access path (P2) via the CM #2. In this way, in the case where each logical volume is associated with a single responsible controller, it is possible to determine a single recommended path for each logical volume. Thus, it is possible to acquire a recommended path using an RTPG command.

On the other hand, in the case of a logical volume such as a TPV, multiple RLU areas with different responsible controllers are often allocated to one TPV as illustrated in FIG. 5. In the example of FIG. 5, two TPVs (TPV1 and TPV2) are provided as logical volumes. The TPV1 includes two chunks. An RLU area R1 is allocated to a chunk C1, and an RLU area R3 is allocated to a chunk C2. Accordingly, a recommended path for accessing the chunk C1 is an access path via the CM #1 which is responsible for the RLU area R1. On the other hand, a recommended path for accessing the chunk C2 is an access path via the CM #2 which is responsible for the RLU area R3.

For example, if recommended paths are managed in units of TPVs as in the case of the management method #1 and an access path via the CM #1 is specified as a recommended path to the TPV1, a cross-access occurs when accessing to the chunk C2. In this case, as illustrated in FIG. 6, by applying the management method #2 which allows management of recommended paths for respective LBA ranges of the TPVs, it is possible to prevent a cross-access from occurring. In the example of FIG. 6, path management information associates recommended paths not with TPV, but with LBA ranges of chunks allocated to the TPVs, as access targets.

In the case where the management method #2 is applied, even when accessing the same TPV1, a recommended path via the CM #1 is selected for accessing the chunk C1, and a recommended path via the CM #2 is selected for accessing the chunk C2. As a result, the occurrence of a cross-access illustrated in FIG. 5 is prevented. However, if recommended path information is reported from the storage control apparatus 200 to the multipath driver 101 each time a new chunk is generated and an RLU area is allocated, the processing load for the reporting operation and the processing load for updating the path management information are increased. For example, in situations in which chunks are frequently created, such as when starting operations of a TPV, the processing load is increased.

Thus, the storage system of the second embodiment detects the occurrence of a cross-access, and executes an operation for updating path management information upon the occurrence of a cross-access. With this structure, even in the case where new chunks are frequently generated, such as when starting operations, it is possible to prevent a reduction in the access performance due to an increase in the processing load. The functions and the like of the storage control apparatus 200 that realize this structure will be described in greater detail.

The above is a description of the storage system of the second embodiment.

(2-2) Hardware

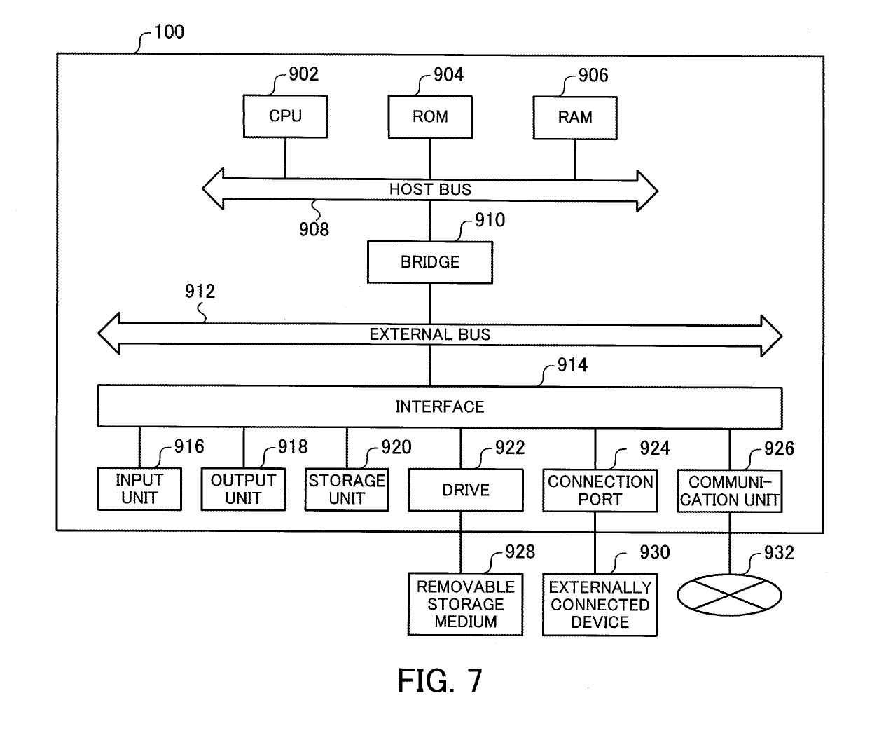

Next, the hardware of the server 100 will be described with reference to FIG. 7. FIG. 7 illustrates an example of the hardware capable of realizing functions of the server 100 according to the second embodiment.

The functions of the server 100 may be realized using the hardware resources of an information processing apparatus illustrated in FIG. 7, for example. That is, the functions of the server 100 are realized by controlling the hardware illustrated in FIG. 7 using a computer program.

As illustrated in FIG. 7, the hardware mainly includes a CPU 902, a read only memory (ROM) 904, a RAM 906, a host bus 908, and a bridge 910. The hardware further includes an external bus 912, an interface 914, an input unit 916, an output unit 918, a storage unit 920, a drive 922, a connection port 924, and a communication unit 926.

The CPU 902 functions as, for example, an arithmetic processing unit or a control device, and controls all or part of the operations of the components based on various programs recorded in the ROM 904, the RAM 906, the storage unit 920, or a removable storage medium 928. The ROM 904 is an example of a storage device that stores programs to be read by the CPU 902, data used for computation, and the like. The RAM 906 temporarily or permanently stores, for example, programs to be read by the CPU 902, various parameters that vary in executing the programs, and the like.

These components are connected to each other via the host bus 908 capable of high speed data transmission. The host bus 908 is connected to the external bus 912 having a relatively low data transmission speed via, for example, the bridge 910. The input unit 916 is, for example, a mouse, a keyboard, a touch panel, a button, a switch, a lever, or the like. Further, the input unit 916 may be a remote controller capable of transmitting a control signal using infrared rays or other electronic waves.

The output unit 918 is, for example, a display device such as a cathode ray tube (CRT), a liquid crystal display (LCD), a plasma display panel (PDP), an electro-luminescence display (ELD), and the like. Further, the output unit 918 may be an audio output device such as a speaker, a headphone, and the like, or may be a printer. That is, the output unit 918 is a device capable of visually or audibly outputting information.

The storage unit 920 is a device for storing various types of data. The storage unit 920 is, for example, a magnetic storage device such as a hard disk drive (HDD) and the like. Further, the storage unit 920 may be a semiconductor storage device (such as a solid state drive (SSD), a RAM disk, and the like), an optical storage device, a magneto-optical storage device, or the like.

The drive 922 is a device that reads information recorded in the removable storage medium 928 as a detachable storage medium, or writes information to the removable storage medium 928. The removable storage medium 928 may be, for example, a magnetic disk, an optical disc, a magneto-optical disk, a semiconductor memory, or the like.

The connection port 924 is a port for connecting an externally connected device 930, such as a universal serial bus (USB) port, an IEEE1394 port, a small computer system interface (SCSI), an RS-232C port, an optical audio terminal, and the like. The externally connected device 930 may be a printer or the like, for example.

The communication unit 926 is a communication device for connection to a network 932. The communication unit 926 is, for example, a communication circuit for a wired or wireless local area network (LAN), a communication circuit for a wireless USB (WUSB), a communication circuit and a router for optical communication, a communication circuit and a router for asymmetric digital subscriber line (ADSL), a communication circuit for a cellular phone network. The network 932 connected to the communication unit 926 is a network connected with a wire or wirelessly, and includes, for example, the Internet, a LAN, a broadcasting network, a satellite communication network, or the like.

The above is a description of the hardware of the server 100. The functions of the storage control apparatus 200 may also be realized using part or all of the hardware illustrated in FIG. 7. Accordingly, the hardware of the storage control apparatus 200 will not be described.

(2-3) Functions of Storage Control Apparatus

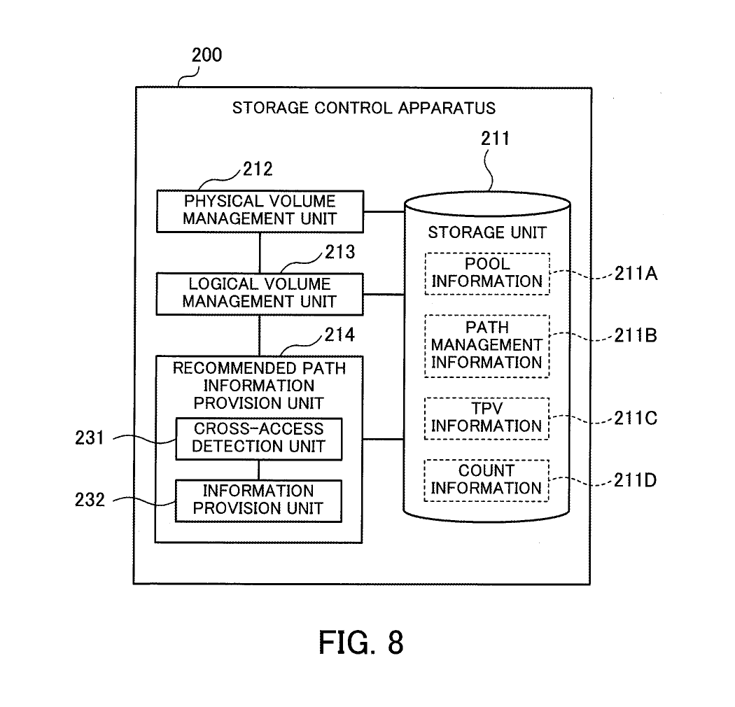

Next, the functions of the storage control apparatus 200 will be described with reference to FIG. 8. FIG. 8 illustrates the functions of the storage control apparatus 200 according to the second embodiment.

As illustrated in FIG. 8, the storage control apparatus 200 includes a storage unit 211, a physical volume management unit 212, a logical volume management unit 213, and a recommended path information provision unit 214.

Note that the functions of the storage unit 211 may be realized using the RAM 906 and the storage unit 920 described above. The functions of the physical volume management unit 212, the logical volume management unit 213, and the recommended path information provision unit 214 may be realized using the CPU 902 described above.

(Storage Unit 211)

The storage unit 211 stores pool information 211A, path management information 211B, TPV information 211C, and count information 211D. The pool information 211A includes information on a disk pool under management and information on RLU areas registered in the disk pool. The path management information 211B includes information that manages the connection status (the validity of access paths) between the ports of the server 100 and the controllers 201 and 202.

The TPV information 211C includes information on TPVs under management and information on chunks allocated to the TPVs. The TPV information 211C further includes information that associates chunks with RLU areas and information on controllers responsible for the RLU areas. The count information 211D includes information that manages the count (the total number or the like) of senses transmitted from the storage control apparatus 200 to the server 100. For example, the count information 211D includes information on the number of times a sense requesting reconstruction of a multipath is transmitted.

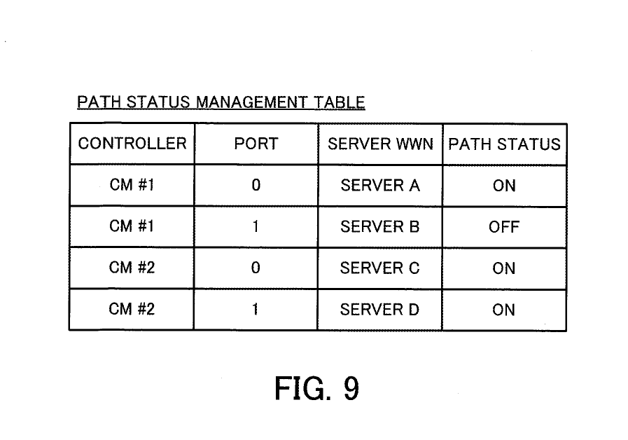

Now, the path management information 211B, the TPV information 211C, and the count information 211D will be described in greater detail with reference to FIGS. 9 through 12.

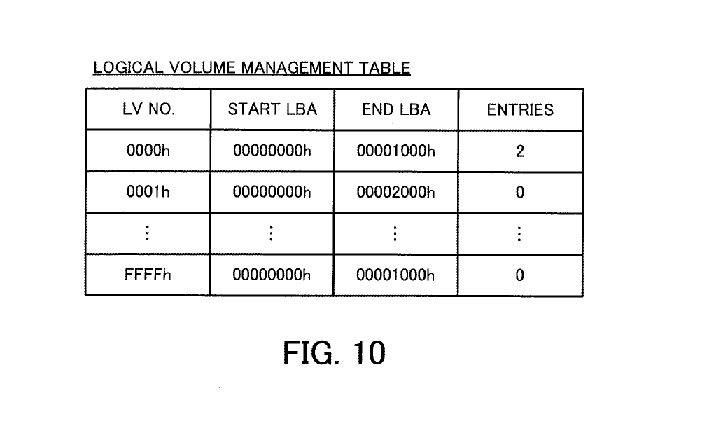

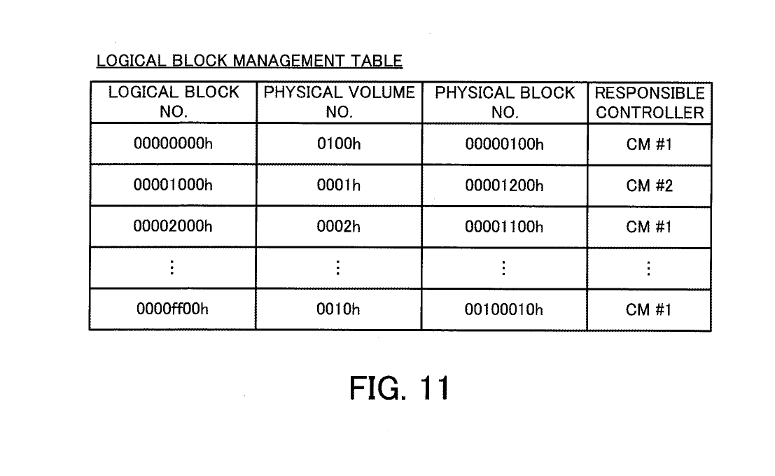

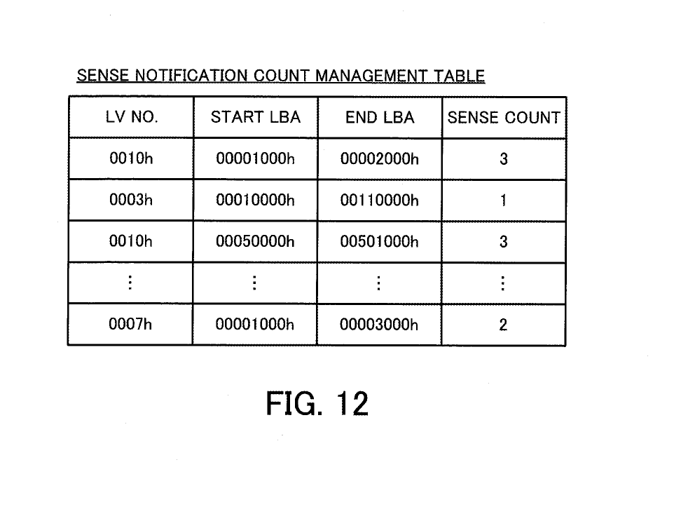

Note that FIG. 9 illustrates an example of a path status management table stored in the storage control apparatus 200 according to the second embodiment. FIG. 10 illustrates an example of a logical volume management table stored in the storage control apparatus 200 according to the second embodiment. FIG. 11 illustrates an example of a logical block management table stored in the storage control apparatus 200 according to the second embodiment. FIG. 12 illustrates an example of a sense notification count management table stored in the storage control apparatus 200 according to the second embodiment.

(Path Management Information 211B)

The path status management table of FIG. 9 is an example of the path management information 211B. The path status management table is provided for each logical volume such as a TPV or the like.

As illustrated in FIG. 9, the path status management table associates information on controllers, information on ports (of the controllers), information on server world wide names (WWNs), and path statuses with each other. Note that a WWN is an identifier for uniquely identifying an apparatus in a storage area network using fiber channels or the like. A server WWN is an identifier for uniquely identifying an HBA installed in the server 100. The path status indicates the connection status between a port and an HBA installed in the server 100.

For example, in the case where a server A logs in to a port 0 of the CM #1, the path status corresponding to the CM #1, the port 0, and the server A is “ON”. In the case where the server A is disconnected from the port 0 of the CM #1 due to a link down of a server port or the like, the path status corresponding to the CM #1, the port 0, and the server A is “OFF”.

In the example of FIG. 9, the path status between the port 0 of the CM #1 and the server A is “ON”, and the path status between a port 1 of the CM #1 and a server B is “OFF”. The path status between a port 0 of the CM #2 and a server C is “ON”, and the path status between a port 1 of the CM #2 and a server D is “ON”. For example, when a controller receives a command from the server 100, if all the ports excluding the port that has received the command are OFF state, notification of a sense is prevented.

(TPV information 211C)

The logical volume management table of FIG. 10 and the logical block management table of FIG. 11 are examples of the TPV information 211C. A TPV is an example of a logical volume. A chunk is an example of a logical block. An RLU area is an example of a physical volume. Further, a part or all of the physical area of an RLU area allocated to each chunk is an example of a physical block.

As illustrated in FIG. 10, the logical volume management table associates a logical volume (LV) number for identifying a logical volume, the start LBA and end LBA of the logical volume, and the number of entries with each other. The number of entries indicates the number of LBA ranges entered in the below-described sense notification count management table. The number of entries is used when the below-described recommended path information provision unit 214 refers to the sense notification count management table. For example, if the number of entries is 0, the recommended path information provision unit 214 does not refer to the sense notification count management table.

In the example of FIG. 10, there is provided a logical volume having an LV number 0000h and having an LBA ranges from 00000000h to 00001000h. The logical volume with the LV number 0000h has two entries in the sense notification count management table. There is also provided a logical volume having an LV number 0001h and having an LBA range from 00000,000h to 00002,000h. The logical volume with the LV number 0001h has no entry in the sense notification count management table. In this manner, information on logical volumes is stored in the logical volume management table.

On the other hand, as illustrated in FIG. 11, the logical block management table associates a logical block number for identifying a logical block, a physical volume number, a physical block number, and a responsible controller with each other. That is, the logical block management table associates a physical block allocated to a logical block indicated by a logical block number with a physical volume including the physical block, and with a controller responsible for the physical volume. Note that the logical block management table is provided for each logical volume.

In the example of FIG. 11, a physical block with a physical block number 00000100h is allocated to the logical block with the logical block number 00000000h. This physical block is included in a physical volume with a physical volume number 0100h. The controller responsible for this physical volume is the CM #1. For example, if the CM #2 different from the responsible controller (CM #1) receives a command requesting access to the logical block with the logical block number 00000000h, the access is determined to be a cross-access. That is, it is possible to detect the occurrence of a cross-access by referring to the logical block management table.

(Count Information 211D)

The sense notification count management table of FIG. 12 is an example of the count information 211D.

As illustrated in FIG. 12, the sense notification count management table associates a LV number, the start LBA and end LBA of the logical volume, and a sense count. The sense count indicates the number of senses transmitted from the storage control apparatus 200 to the server 100. For example, if the sense count exceeds a predetermined threshold, notification of a sense to the server 100 to which the corresponding logical volume is allocated is prevented. Further, if a change is made to the logical volume, such as when the physical block allocated to the corresponding LBA range is moved, the corresponding entry is removed.

(Physical Volume Management Unit 212)

Referring again to FIG. 8, the physical volume management unit 212 manages the pool information 211A. For example, the physical volume management unit 212 performs a process of registering an RLU area in a disk pool, a process of managing the usage of the RLU area, and the like.

(Logical Volume Management Unit 213)

The logical volume management unit 213 manages the TPV information 211C. For example, the logical volume management unit 213 performs a process of registering a chunk in a TPV, a process of allocating an RLU area to the chunk, and the like. When a new TPV is provided, for example, the logical volume management unit 213 adds information on the newly provided TPV to the TPV information 211C. Further, when a new chunk is registered for a TPV, the logical volume management unit 213 updates the TPV information 211C for the newly registered chunk.

(Recommended Path Information Provision Unit 214)

The recommended path information provision unit 214 transmits to the server 100 a sense requesting reconstruction of a multipath when a cross-access is detected. Further, upon receiving an RR command transmitted from the server 100 in response to the sense, the recommended path information provision unit 214 provides the server 100 with information on a recommended path specified for each LBA range. For realizing these functions, the recommended path information provision unit 214 includes a cross-access detection unit 231 and an information provision unit 232.

The cross-access detection unit 231 refers to the TPV information 211C (for example, the logical block management table), and specifies a controller responsible for the access target logical block indicated by the command. Further, the cross-access detection unit 231 determines whether the controller that has received the command is the responsible controller. If the controller that has received the command is not the responsible controller, the cross-access detection unit 231 determines that a cross-access has occurred. In this manner, the cross-access detection unit 231 detects the occurrence of a cross-access.

For example, if a Write command to the logical block with the logical block number 00001000h is received, the cross-access detection unit 231 refers to the logical block management table of FIG. 11, and specifies the responsible controller (CM #2). Further, the cross-access detection unit 231 determines whether the controller that has received the Write command is the CM #2. If the controller that has received the Write command is the CM #1, the cross-access detection unit 231 determines that a cross-access has occurred. Having detected the cross-access, the cross-access detection unit 231 notifies the information provision unit 232 of the occurrence of a cross-access.

Having been notified of the occurrence of a cross-access, the information provision unit 232 transmits a sense requesting reconstruction of a multipath to the server 100. Further, the information provision unit 232 updates the sense count in the count information 211D (for example, sense notification count management table). Note that if the number of entries in the sense notification count management table is changed, the information provision unit 232 updates the number of entries in the logical volume management table as well. If an RR command is issued in response to the transmitted sense, the information provision unit 232 refers to the TPV information 211C (for example, the logical block management table), and provides the server 100 with information on an access path (recommended path) via the responsible controller.

The above is a description of the functions of the storage control apparatus 200.

(2-4) Process Flow

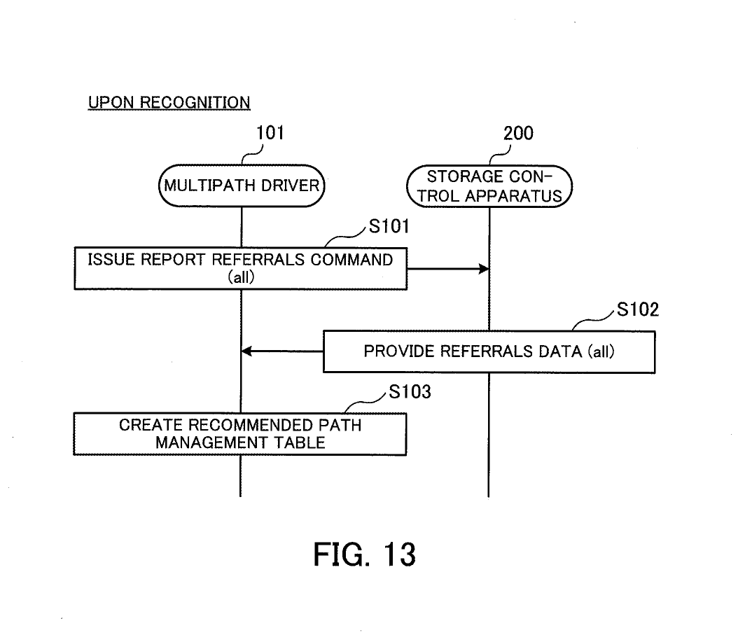

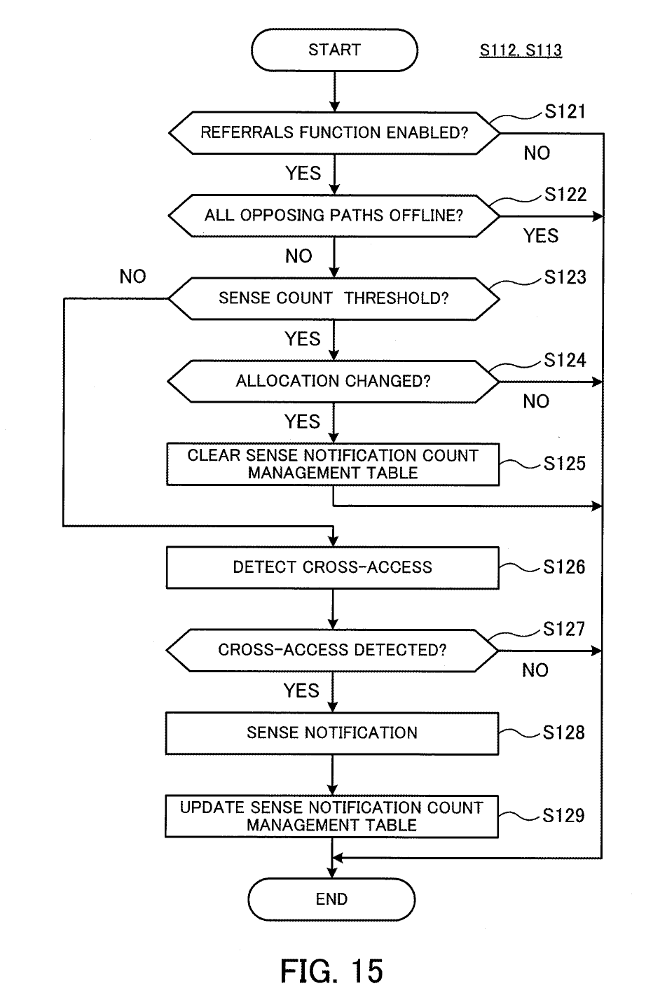

The flow of the process performed by the storage system of the second embodiment will be described with reference to FIGS. 13 and 15. The operations performed when the multipath driver 101 recognizes the storage control apparatus 200 (operations upon recognition) and the operations performed when a cross-access is detected (operations upon cross-access detection) will be described separately.

(Operations Upon Recognition)

First, the flow of a process performed when the multipath driver 101 recognizes the storage control apparatus 200 will be described with reference to FIG. 13. FIG. 13 illustrates an example of operations of the storage system (operations upon recognition) according to the second embodiment.

(S101) The multipath driver 101 issues an RR command. More specifically, the multipath driver 101 issues an RR command (all) requesting recommended paths for respective LBA ranges of all the chunks registered in TPVs managed by the storage control apparatus 200.

(S102) Having received the RR command (all), the storage control apparatus 200 provides REFERRALS data (all) to the server 100. The REFERRALS data (all) includes information on recommended paths for respective LBA ranges of all the chunks registered in TPVs managed by the storage control apparatus 200. For example, the storage control apparatus 200 refers to the TPV information 211C and provides the server 100 with information indicating the relationship between the LBA ranges of each TPV and the responsible controllers, using the function of the recommended path information provision unit 214.

(S103) Having received the REFERRALS data (all), the multipath driver 101 creates a recommended path management table based on the received REFERRALS data (all). The recommended path management table stores, for each TPV, information that associates the LBA ranges of each TPV and recommended paths (responsible controllers). The recommended path management table is referred to when the server 100 accesses a TPV, and is used for selecting a controller (access path) to which a command is transmitted when making an access.

This is the flow of the process performed upon recognition.

(Operations Upon Cross-Access Detection)

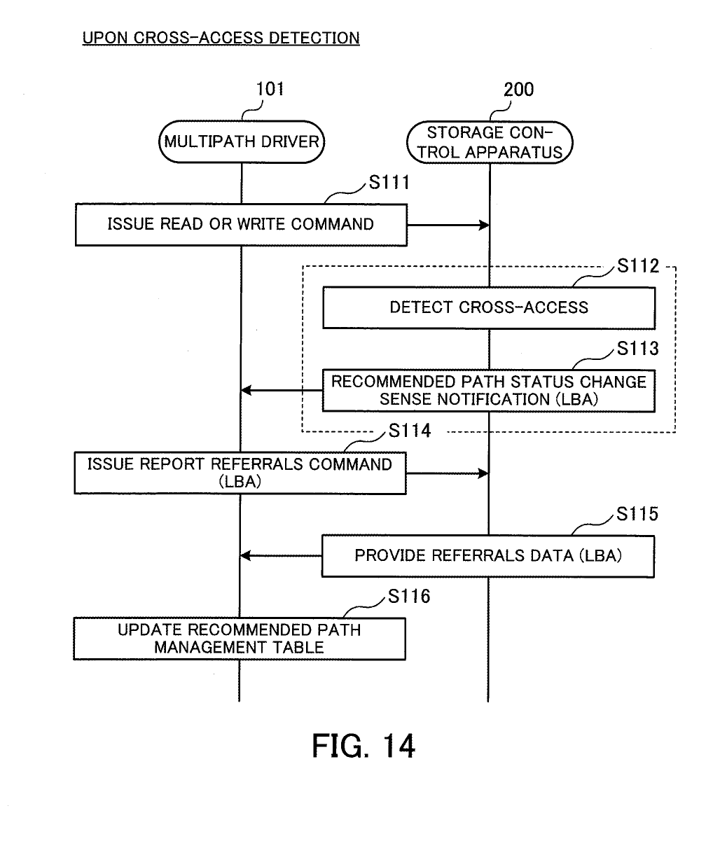

Next, the flow of a process performed when detecting a cross-access will be described with reference to FIGS. 14 and 15. FIG. 14 is a first diagram illustrating an example of operations of the storage system (operations upon cross-access detection) according to the second embodiment. FIG. 15 is a second diagram illustrating an example of operations of the storage system (operations upon cross-access detection) according to the second embodiment.

(S111) The multipath driver 101 issues a command (a Read command or a Write command) to the storage control apparatus 200.

(S112) Having received the command from the multipath driver 101, the storage control apparatus 200 performs detection of a cross-access, using the function of the recommended path information provision unit 214. For example, the recommended path information provision unit 214 refers to the TPV information 211C (the logical block management table), and determines whether the controller that has received the command is the responsible controller. If the controller that has received the command is not the responsible controller, the recommended path information provision unit 214 determines that a cross-access has occurred.

(S113) If a cross-access is detected, the storage control apparatus 200 transmits to the multipath driver 101 a sense for notifying of a status change of the recommended path (reconstruction of a multipath), using the function of the recommended path information provision unit 214. More specifically, the recommended path information provision unit 214 transmits to the multipath driver 101 a sense for notifying of a status change of the recommended path for the LBA range with which the cross-access is detected.

(S114) Having been notified of the status change of the recommended path from the storage control apparatus 200, the multipath driver 101 issues an RR command (LBA). Unlike the above-described RR command (all), the RR command (LBA) is a command that requests reporting of information on a recommended path for a specific LBA range (in this case, the LBA range with which the cross-access is detected). That is, the multipath driver 101 issues an RR command (LBA) specifying the LBA range indicated by the sense received from the storage control apparatus 200.

(S115) Having received the RR command (LBA), the storage control apparatus 200 provides REFERRALS data (LBA) to the server 100. The REFERRALS data (LBA) includes information on the recommended path for the LBA range with which the cross-access occurred. For example, the storage control apparatus 200 refers to the TPV information 211C and provides the server 100 with information indicating the relationship between the LBA range specified by the RR command (LBA) and the responsible controller, using the function of the recommended path information provision unit 214.

(S116) Having received the REFERRALS data (LBA), the multipath driver 101 updates the recommended path management table based on the received REFERRALS data (LBA). The updated recommended path management table is referred to when the server 100 accesses a TPV, and is used for selecting a controller (access path) to which a command is to be transmitted when making an access.

Now, operations of the storage control apparatus 200 in steps S112 and S113 will be described in greater detail with reference to FIG. 15. A set of operations illustrated in FIG. 15 is mainly performed by the recommended path information provision unit 214 of the storage control apparatus 200.

(S121) The recommended path information provision unit 214 determines whether a REFERRALS function for using RR commands is enabled. If the REFERRALS function is enabled, the process proceeds to step S122. On the other hand, if the REFERRALS function is not enabled, a set of operations illustrated in FIGS. 13 through 15 ends.

(S122) The recommended path information provision unit 214 refers to the path management information 211B (for example, the path status management table), and determines whether all the opposing paths (paths passing through the ports excluding the port that has received the command) are offline (path status=“OFF”). If all the opposing paths are offline, the set of operations of FIGS. 13 through 15 ends (sense notification is prevented). On the other hand, if at least one of the opposing paths is not offline, the process proceeds to step S123.

(S123) The recommended path information provision unit 214 refers to the count information 211D (for example, the sense notification count management table), and determines whether the sense count of the LBA range that is accessed in accordance with the command has reached a predetermined threshold (whether the sense count is equal to or greater than the threshold). If the sense count has reached the threshold, the process advances to step S124. On the other hand, if the sense count has not reached the threshold, the process advances to step S126.

(S124) The recommended path information provision unit 214 determines whether allocation of the physical area (allocation of RLU areas to chunks) is changed. If the allocation is changed, the process proceeds to step S125. On the other hand, if there is no change in the allocation, the set of operations of FIGS. 13 through 15 ends (sense notification is prevented).

(S125) The recommended path information provision unit 214 clears entries in the count information 211D (sense notification count management table). When the operation of step S125 completes, the set of operations of FIGS. 13 through 15 ends (sense notification is prevented).

(S126) The recommended path information provision unit 214 performs detection of a cross-access. For example, the recommended path information provision unit 214 refers to the TPV information 211C (the logical block management table), and determines whether the controller that has received the command is the responsible controller. If the controller that has received the command is not the responsible controller, the recommended path information provision unit 214 determines that a cross-access has occurred.

(S127) If a cross-access is detected in step S126, the process proceeds to step S128. On the other hand, if no cross-access is detected in step S126, the set of operations of FIGS. 13 through 15 ends (sense notification is prevented).

(S128) The recommended path information provision unit 214 transmits to the multipath driver 101 a sense for notifying of a status change of the recommended path (reconstruction of a multipath). More specifically, the recommended path information provision unit 214 transmits to the multipath driver 101 a sense for notifying of a status change of the recommended path for the LBA range with which the cross-access is detected.

(S129) The recommended path information provision unit 214 updates the count information 211D (sense notification count management table). When the processing of step S129 completes, the set of operations of FIGS. 13 through 15 ends (sense notification is prevented).

This is the flow of the process performed upon cross-access detection.

The above is a description of the flow of the process performed by the storage system of the second embodiment.

As described above, with the technique of the second embodiment, it is possible to prevent notification of a change to the recommended path from being performed each time there is an access from the server 100 in an initial state in which no chunk is allocated to a TPV, and thus to prevent a reduction in the access performance. Further, since an LBA range is specified when notifying of a change to the recommended path, it is possible to reduce the communication load and the processing load compared to the case in which the processing of changing the recommended path is performed for all the LBA ranges.

Further, since sense notification upon an allocation change is prevented, it is possible to prevent unneeded sense notification from being performed when a recommended path is temporarily unavailable due to the path being blocked or the like. Thus, it is possible to reduce the processing load for changing the recommended path. Further, even if part of information is not provided for some reason when providing the information, since recommended path information is provided to the server 100 upon detection of a cross-access, it is possible to provide the information again upon occurrence of the cross-access. Accordingly, it is possible to prevent a reduction in the access performance due to incomplete reporting.

The above is a description of the second embodiment.

According to an aspect, it is possible to reduce the processing load for updating a recommended path.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage control apparatus comprising:
a plurality of processors that each controls access to one or more first storage areas among a plurality of first storage areas allocated to one or more data storage media; and
a memory configured to store information, for each of the processors, on one or more second storage areas to which unit storage areas reserved in the corresponding one or more first storage areas are allocated;
wherein when one of the processors receives an access request to a unit storage area reserved in a first storage area different from the corresponding one or more first storage areas, the one of the processors provides information on another of the processors that controls access to the different first storage area as an access path to the unit storage area.

2. The storage control apparatus according to claim 1, wherein the information provided as the access path to the unit storage area is information indicating a corresponding relationship between an address of the unit storage area in one of the second storage areas and the another of the processors that controls access to the different first storage area.

3. The storage control apparatus according to claim 1, wherein the one of the processors stores, for each of the second storage areas, a number of times the information was provided, and provides the information related to the second storage area when the number of times the information was provided is less than a specified threshold.

4. The storage control apparatus according to claim 3, wherein when the unit storage area allocated to the second storage area is changed or when corresponding relationship between the unit storage area and the first storage area is changed, the one of the processors resets the number of times the information related to the second storage area was provided.

5. A control method performed by a computer including a plurality of processors and a memory, wherein the plurality of processors each controls access to one or more first storage areas among a plurality of first storage areas allocated to one or more data storage media, and wherein the memory is configured to store information, for each of the processors, on one or more second storage areas to which unit storage areas reserved in the corresponding one or more first storage areas are allocated, the control method comprising:
providing, by one of the processors, when the one of the processors receives an access request to a unit storage area reserved in a first storage area different from the corresponding one or more first storage areas, information on another of the processors that controls access to the different first storage area as an access path to the unit storage area.

6. The control method according to claim 5, wherein the information provided as the access path to the unit storage area is information indicating a corresponding relationship between an address of the unit storage area in one of the second storage areas and the another of the processors that controls access to the different first storage area.

7. The control method according to claim 5, wherein the one of the processors stores, for each of the second storage areas, a number of times the information was provided, and provides the information related to the second storage area when the number of times the information was provided is less than a specified threshold.

8. The control method according to claim 7, wherein when the unit storage area allocated to the second storage area is changed or when corresponding relationship between the unit storage area and the first storage area is changed, the one of the processors resets the number of times the information related to the second storage area was provided.

9. A computer-readable storage medium storing a computer program that causes a computer to perform a procedure, the computer including a plurality of processors and a memory, wherein the plurality of processors each controls access to one or more first storage areas among a plurality of first storage areas allocated to one or more data storage media, and wherein the memory is configured to store information, for each of the processors, on one or more second storage areas to which unit storage areas reserved in the corresponding one or more first storage areas are allocated, the procedure comprising:
when one of the processors receives an access request to a unit storage area reserved in a first storage area different from the corresponding one or more first storage areas, providing information on another of the processors that controls access to the different first storage area as an access path to the unit storage area.
